(19) United States
(12) Patent Application Publication
(10) Pub. No.: US 2005/0010011 A1
(43) Pub. Date: Jan. 13, 2005

(54) NCO compounds with covalently bonded polyhedral oligomeric silicon-oxygen cluster units

(75) Inventors: Emmanouil Spyrou, Dorsten (DE); Friedrich-Georg Schmidt, Haltern am See (DE); Adolf Kuhnle, Marl (DE); Carsten Jost, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/887,084

(22) Filed: Jul. 9, 2004

(30) Foreign Application Priority Data
Jul. 11, 2003 (DE) 103 31 787.2

(51) Int. Cl. C08G 18/00

(52) U.S. Cl. 528/28; 528/29

(57) ABSTRACT

NCO compounds with covalently bonded polyhedral oligomeric silicon-oxygen cluster units and good solubility are suitable as crosslinkers in coating systems. The NCO compounds lead to improved coating properties, such as good leveling of cured baking varnishes.

### BACKGROUND OF THE INVENTION

1. Field of the Invention

The present invention relates to NCO compounds. In particular, the present invention relates to NCO compounds with covalently bonded polyhedral oligomeric silicon-oxygen cluster units that are suitable as crosslinkers in coating systems.

2. Discussion of the Background

Polyisocyanates, blocked or not, and their use in one- and two-component polyurethane systems are known. They give topcoats resistance to environmental effects, especially acid rain, which is significantly improved in comparison to amino-resin-crosslinking systems. One of the uses of polyisocyanates is proportionally in combination with amino resins as a crosslinker component in what are termed hybrid systems. Blocked polyisocyanates further possess considerable importance in the field of thermosetting powder coating materials.

In contrast to polymers processed using high-shear-force equipment such as extruders and compounders, for example, paints are produced frequently using stirring and mixing equipment. Because of the lower homogenizing action in this case and the multiplicity of individual components, accordingly, there are incompatibilities in the formulation and, in particular, surface defects in the applied coating. As a result not only is the esthetic appearance impaired but there may also be a decrease in the mechanical properties.

### SUMMARY OF THE INVENTION

The present invention provides new compounds suitable as crosslinkers in coating materials for obtaining higher scratch resistance, water repellency, and improved dirt repellency and for raising the glass transition temperature (Tg), but without leading to incompatibilities and surface defects. The new compounds are NCO compounds with covalently bonded polyhedral oligomeric silicon-oxygen cluster units.

### DETAILED DESCRIPTION OF PREFERRED EMBODIMENTS

The invention provides NCO compounds with covalently bonded polyhedral oligomeric silicon-oxygen cluster units synthesized by reacting as starting components
A) at least one aromatic, aliphatic and/or cycloaliphatic polyisocyanate having an NCO functionality of from 2 to 6,
B) from 0.001 to 20.0% by weight of polyhedral oligomeric silicon-oxygen cluster units having at least one functional group reactive toward isocyanate groups, from 1 to 20 mol % of the free isocyanate groups originally present in the polyisocyanate having undergone reaction,
C) if desired a blocking agent, in which case from 80 to 99 mol % of the free isocyanate groups originally present in the polyisocyanate have undergone reaction,
and the molar fractions of the reacted isocyanate groups add up to 100%.

The polyisocyanate of component A) is based on hexamethylene diisocyanate (HDI), isophorone diisocyanate (IPDI), bis(4-isocyanatocyclohexyl)methane (H₁₂-MDI), tetramethylxylylene diisocyanate (TMXDI), 1,3-bis(isocyanatomethyl)cyclohexane (1,3-H-XDI), 2,2,4- and 2,4,4-trimethyl-1,6-diisocyanatohexane (TMD), 2-methylpentene 1,5-diisocyanate (MPDI), norbornyl diisocyanate (NBDI), lysine triisocyanate (LTI) or 4-isocyanatomethyl-1,8-octamethylene diisocyanate (NTI), 2,4-diisocyanatomethylbenzene (2,4-TDI), 2,6-diisocyanatomethylbenzene (2,6-TDI), diphenylmethane diisocyanate or mixtures of these diisocyanates and has a mean NCO functionality of 2.0-6.0.

In the case of a functionality of more than two it is preferred to use polyisocyanates—alone or in mixtures—as prepared by trimerization, dimerization or formation of urethanes, biurets or allophanates, and also blends of these with monomers. Polyisocyanates or polyisocyanate/monomer mixtures of this kind can be additionally chain-extended or branched where appropriate with difunctional or polyfunctional H-acidic components such as diols or polyols and/or diamines or polyamines, for example.

Component A) is based preferably on IPDI and/or HDI, in particular on isocyanurates of these diisocyanates.

The polyhedral oligomeric silicon-oxygen cluster used in accordance with the invention as component B) preferably connotes the two classes of compound of the silsesquioxanes and of the spherosilicates.

Silsesquioxanes are oligomeric or polymeric substances whose completely condensed representatives possess the general formula (SiO_{3/2}R)ₙ, where n>4 and the radical R can be a hydrogen atom but is usually an organic radical. The smallest structure of a silsesquioxane is the tetrahedron. Voronkov and Lavrent'yev (Top. Curr. Chem. 102 (1982), 199-236) describe the synthesis of completely and of incompletely condensed oligomeric silsesquioxanes by hydrolytic condensation of trifunctional RSiY3 precursors, where R is a hydrocarbon radical and Y is a hydrolyzable group, such as chloride, alkoxide or siloxide, for example. Lichtenhan et al. describe the base-catalyzed preparation of oligomeric silsesquioxanes (WO 01/10871). Silsesquioxanes of the formula R₈Si₈O₁₂ (with identical or different hydrocarbon radicals R) can be reacted with base catalysis to functionalized, incompletely condensed silsesquioxanes, such as R₇Si₇O₉(OH)₃ or else R₈Si₈O₁₁(OH)₂ and R₈Si₈O₁₀(OH)₄, for example (Chem. Commun. (1999), 2309-10; Polym. Mater. Sci. Eng. 82 (2000), 301-2; WO 01/10871) and hence may serve as a parent compound for a multiplicity of different incompletely condensed and functionalized silsesquioxanes. The silsesquioxanes (trisilanols) of the formula R₇Si₇O₉(OH)₃ in particular can be reacted with functionalized monomeric silanes (comer capping) and so converted into correspondingly modified oligomeric silsesquioxanes.

Oligomeric spherosilicates have a construction similar to that of the oligomeric silsesquioxanes. They too possess a “cagelike” structure. Unlike the silsesquioxanes, owing to the method by which they are prepared, the silicon atoms at the comers of a spherosilicate are connected to a further oxygen atom, which in turn is further substituted. Oligomeric spherosilicates can be prepared by silylating suitable silicate precursors (D. Hoebbel, W. Wieker, Z. Anorg. Allg. Chem. 384 (1971), 43-52; P. A. Agaskar, Colloids Surf. 63 (1992), 131-8; P. G. Harrison, R. Kannengiesser, C. J. Hall, J. Main Group Met. Chem. 20 (1997), 137-141; R. Weidner, Zeller, B. Deubzer, V. Frey, Ger. Offen. (1990), DE 38 37 397). For example, the spherosilicate with structure 2 can be synthesized from the silicate precursor of structure 1, which in turn is obtainable by reaction of Si(OEt)₄ with choline silicate or by the reaction of waste products from the harvesting of rice with tetramethylammonium hydroxide (R. M. Laine, I. Hasegawa, C. Brick, J. Kampf, Abstracts of Papers, 222nd ACS National Meeting, Chicago, Ill., United States, August 26-30, 2001, MTLS-01 8).

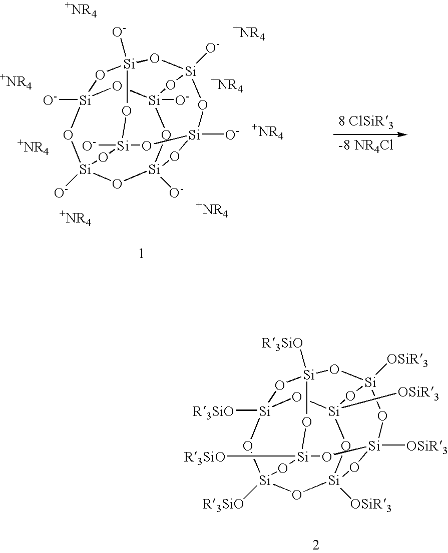

Both the silsesquioxanes and the spherosilicates are thermally stable at temperatures of up to several hundred degrees Celsius.

Used inventively as component B) is a polyhedral oligomeric silicon-oxygen cluster unit in accordance with the formula
[(RₐX_{b}SiO_{1.5})ₘ(R_{c}X_{d}SiO)ₙ(RₑX_{f}Si₂O_{2.5})₀(R_{g}XₕSi₂O₂)ₚ]
where:

a,b,c=0-1; d=1-2; e,f,g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl or cycloalkynyl group or polymer unit, each of which is substituted or unsubstituted, or further functionalized polyhedral oligomeric silicon-oxygen cluster units attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino, phosphine or polyether group, or substituents of type R containing at least one such group of type X,

the substituents of type R being identical or different, and

the substituents of type X being identical or different.

Owing to their molecular nature, the polyhedral oligomeric silicon-oxygen clusters possess a uniform and defined molecular weight. In one particular embodiment of the masterbatch of the invention the polyhedral oligomeric silicon-oxygen cluster unit has a molecular weight of preferably at least 400 g/mol, more preferably 400 to 2500 g/mol, and very preferably from 600 to 1500 g/mol.

The polyhedral oligomeric silicon-oxygen clusters have a size of not more than 100 nm, preferably not more than 50 nm, more preferably not more than 30 nm, and very preferably not more than 20 nm.

It can be advantageous if the polyhedral oligomeric silicon-oxygen cluster unit of the invention is based on structure 3 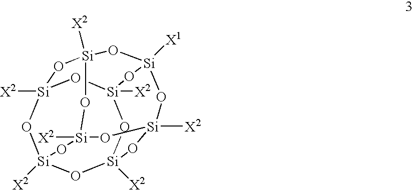
where X¹=substituent of type X or of type —O—SiX₃, and

X²=substituent of type X, of type —O—SiX₃, of type R, of type —O—SiX₂R, of type —O—SiXR₂ or of type 13 O—SiR₃.

The polyhedral oligomeric silicon-oxygen cluster unit used as component B) is preferably functionalized; in particular the polyhedral oligomeric silicon-oxygen cluster unit is a spherosilicate unit in accordance with the formula
[(RₑX_{f}Si₂O_{2.5})₀(R_{g}XₕSi₂O₂)ₚ] where e,f,g=0-3; h=1-4; o+p≧4; e+f3, and g+h=4,
but preferably a functionalized oligomeric spherosilicate unit, but more preferably a silsesquioxane unit in accordance with the formula
[(RₐX_{b}SiO_{1.5})ₘ(R_{c}X_{d}Si_{O})ₙ] with a,b,c=0-1; d=1-2; m+n≧4; a+b=1; c+d=2,
but very preferably a functionalized oligomeric silsesquioxane unit. Very particular preference is given to silicon-oxygen cluster units based on an oligomeric silsesquioxane unit in accordance with structures 4, 5 or 6 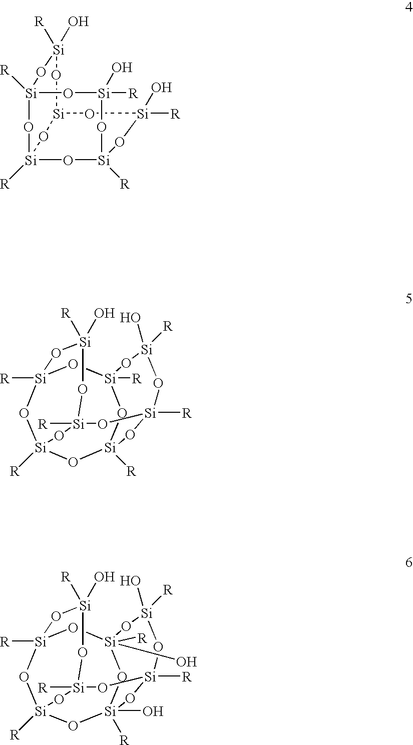
with R=a hydrogen atom, alkyl, cycloalkyl, alkenyl, cycloalkenyl, alkynyl or cycloalkynyl group or polymer unit, each of which is substituted or unsubstituted, or further functionalized oligomeric silsesquioxane units attached via a polymer unit or a bridge unit.

The functionalized oligomeric silsesquioxane unit can be obtained by reacting silsesquioxanes having free hydroxyl groups with monomeric functionalized silanes of structure Y₃Si—X¹, Y₂SiX¹X² and YSiX¹X²X³, the substituent Y being a leaving group selected from alkoxy, carboxyl, halo, silyloxy and amino group, the substituents X¹, X² and X³ being of type X and being identical or different, where X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino, phosphine or polyether group, or substituents of type R containing at least one such group of type X, and R is a hydrogen atom, an alkyl, cycloalkyl, alkenyl, cycloalkenyl, alkynyl or cycloalkynyl group or a polymer unit, each of which is substituted or unsubstituted, or further functionalized oligomeric silsesquioxane units attached via a polymer unit or a bridge unit.

The substituents of type R of the silsesquioxane can all be identical, producing what is termed a functionalized homoleptic structure, as follows:
[(RSiO_{1.5})ₘ(RXSiO)ₙ]
with m+n=z and z≧4, z corresponding to the number of silicon atoms in the framework structure of the polyhedral oligomeric silicon-oxygen cluster unit, and
R=a hydrogen atom, an alkyl, cycloalkyl, alkenyl, cycloalkenyl, alkynyl or cycloalkynyl group or a polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino, phosphine or polyether group, or substituents of type R containing at least one such group of type X,
the substituents of type R being identical or different, and
the substituents of type X being identical or different.

In a further embodiment it is possible for at least two of the substituents of type R of the polyhedral oligomeric silsesquioxane unit to be different, in which case it is said to have a functionalized heteroleptic structure, as follows:
[(RSiO_{1.5})ₘ(R′XSiO)ₙ]
with m+n=z and z≧4, z corresponding to the number of silicon atoms in the framework structure of the polyhedral oligomeric silicon-oxygen cluster unit, and R≠R′=a hydrogen atom, an alkyl, cycloalkyl, alkenyl, cycloalkenyl, alkynyl or cycloalkynyl group or a polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino, phosphine or polyether group, or substituents of type R containing at least one such group of type X,
the substituents of type R being identical or different, and
the substituents of type X being identical or different.

It can be especially advantageous if the polyhedral oligomeric silicon-oxygen cluster unit of inventive component B) contains not more than one substituent of type X. In particular it is possible in this way to prevent instances of crosslinking between the polyhedral oligomeric silicon-oxygen clusters themselves.

With very particular preference the inventive component B) comprises functionalized oligomeric silsesquioxanes of the formula 7

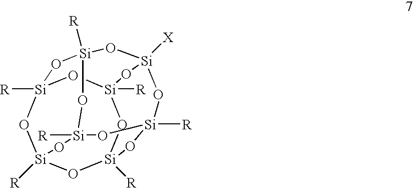

Suitable blocking agents C) are blocking agents known in polyurethane technology, such as ketoximes, aldoximes, 1,2,4-triazoles, including those in substituted form, pyrazoles, including those in substituted form, especially 3,5-dimethylpyrazole, lactams, especially c-caprolactam, CH-acidic blocking agents from the group of the malonates or acetoacetates, phenols, substituted phenols, secondary amines, especially sterically hindered amines such as diisopropylamine, or C1-C₁₀ monoalcohols. These blocking agents can be used as they are or else in the form of mixtures for preparing the silane-modified crosslinkers of the invention. Preference is given to oximes, caprolactam, 3,5-dimethylpyrazole or 1,2,4-triazole, and secondary amines.

The NCO compounds of the invention with covalently bonded polyhedral oligomeric silicon-oxygen cluster units are generally prepared by modification of polyisocyanates.

In the case of the blocked systems the modification of the polyisocyanates can be performed in succession in the form of a reaction with the polyhedral oligomeric silicon-oxygen cluster unit followed by blocking, or else by blocking followed by reaction with the polyhedral oligomeric silicon-oxygen cluster unit. Less preferred but still embraced by the invention is the reaction of polyisocyanate with a mixture of the polyhedral oligomeric silicon-oxygen cluster unit and blocking agent. A particularly preferred process comprises first blocking the polyisocyanate and then reacting it with the polyhedral oligomeric silicon-oxygen cluster unit.

The preparation can take place in solvent, in which case the solvent is preferably nonprotic and anhydrous. Solvent-free preparation techniques are appropriate, given appropriate viscosity of the products in a stirred reactor regime; where the products are of relatively high viscosity, continuous preparation in a reaction extruder is appropriate.

The NCO compounds of the invention with covalently bonded polyhedral oligomeric silicon-oxygen cluster units are prepared in the temperature range from 20° C. to 200° C., preferably from 20 to 150° C.

In order to accelerate the reaction, where necessary, it is also possible to use catalysts customary in polyurethane (PU) technology, from the group consisting of Sn(II), Sn(IV), Zn(II), and Bi compounds or tertiary amines, or combinations of metal catalyst. and tertiary amine.

In pure form the products can be obtained as liquids or solids and for liquid coating applications may be dissolved where appropriate in organic solvents.

Following appropriate modification the NCO compounds of the invention with covalently bonded polyhedral oligomeric silicon-oxygen cluster units can also be used for nonpulverulent radiation-curing formulations. For this purpose said compounds of the invention are reacted partly or fully with substances which not only possess a unit which is reactive toward NCO groups but also include a functionality which can be polymerized radically or cationically. Examples of such compounds are hydroxyethyl acrylate or methacrylate, hydroxypropyl acrylate or methacrylate, and hydroxybutyl acrylate or methacrylate.

It is also readily possible to change the sequence of the two component steps, namely functionalization with polyhedral oligomeric silicon-oxygen cluster units and functionalization with radiation-curable substances. The use of NCO substances as a constituent of radiation-curable urethane acrylates is widely described in the literature, e.g., in DE 197 41 781.

The reaction of the NCO compounds of the invention with covalently bonded polyhedral oligomeric silicon-oxygen cluster units with said radiation-curable substances takes place in the temperature range from 20° C. to 200° C., preferably from 20 to 150° C.

In order to accelerate the reaction, where necessary, it is also possible to use catalysts customary in PU technology, selected from the group consisting of Sn(II), Sn(IV), Zn(II), and Bi compounds or tertiary amines, or combinations of metal catalyst and tertiary amine.

These radiation-curable substances containing covalently bonded polyhedral oligomeric silicon-oxygen cluster units can be cured under the influence of UV radiation both as they are or in a mixture with other radiation-curable compounds and in the presence of photoinitiators. One possible version is to cure using electron beams, in which case addition of photoinitiators is unnecessary. Radiation-curable formulation and the curing thereof has already been described in numerous instances in the patent literature, e.g., in DE 197 39 970.

The NCO compounds of the invention with covalently bonded polyhedral oligomeric silicon-oxygen cluster units are used in particular in coating materials. These materials can be cured either at room temperature, by exposure to heat, atmospheric humidity or radiation. Such formulations are essentially composed of crosslinker component and polyol component, additives, optionally solvents, and organic or inorganic color pigments, fillers or dyes.

The invention also provides for the use of NCO compounds with covalently bonded polyhedral oligomeric silicon-oxygen cluster units, synthesized by reacting as starting components
A) at least one aromatic, aliphatic and/or cycloaliphatic polyisocyanate having an NCO functionality of from 2 to 6,
B) from 0.001 to 20.0% by weight of polyhedral oligomeric silicon-oxygen cluster units having at least one functional group reactive toward isocyanate groups, from 1 to 20 mol % of the free isocyanate groups originally present in the polyisocyanate having undergone reaction,
C) if desired a blocking agent, in which case from 80 to 99 mol % of the free isocyanate groups originally present in the polyisocyanate have undergone reaction,
and the molar fractions of the reacted isocyanate groups add up to 100%, for preparing coating materials, especially heat-curable, moisture-curable, and radiation-curable coating materials.

Hence the invention additionally provides coating materials essentially comprising at least one polyol component and the NCO compounds of the invention with covalently bonded polyhedral oligomeric silicon-oxygen cluster units as crosslinkers, and also provides the coatings produced from the coating materials.

In this case the polyisocyanate of the invention modified with the polyhedral oligomeric silicon-oxygen cluster unit may constitute the sole crosslinker component of the baking varnish system or may be used in combination with other crosslinkers for hydroxyl-containing film-forming resins in thermosetting coatings, for example, from the groups of the blocked polyisocyanates, the amino resins such as melamine resins, benzoguanamine resins, glycoluril resins or urea resins (J. Ott in: Stoye-Freitag, Lackharze, Carl-Hanser-Verlag, 1996, p. 104 ff.), or else from the group of the triazine carbamates as described in, for example, U.S. Pat. No. 5084541. The (optionally blocked) polyisocyanate modified with the polyhedral oligomeric silicon-oxygen cluster unit represents from 10 to 100 parts by weight of the crosslinkers, based on nonvolatile constituents.

Suitable polyol components for crosslinking include (meth)acrylic copolymers, polyesterpolyols, polyols containing urethane groups and ester groups, polyetherpolyols and/or polycarbonatediols.

As hydroxyl-containing (meth)acrylic copolymers it is possible to use resins having a monomer composition as described in, for example, WO 93/15849 (p. 8 line 25 to p. 10 line 5) or else DE 195 29 124. The acid number of the (meth)acrylic copolymer to be set as a result of the proportional use of (meth)acrylic acid as monomer should be 0-30, preferably 3-15. The number-average molar weight (determined by gel permeation chromatography against a polystyrene standard) of the (meth)acrylic copolymer is preferably from 2000 to 20000 g/mol while the glass transition temperature is preferably from −40° C. to +60° C. The hydroxyl content of the (meth)acrylic copolymers for inventive use that is to be set by proportional use of hydroxyalkyl (meth)acrylates is preferably from 70 to 250 mg KOH/g, more preferably from 90 to 190 mg KOH/g.

Polyesterpolyols suitable in accordance with the invention are resins having a monomer composition of dicarboxylic and polycarboxylic acids and diols and polyols, as described in, for example, Stoye/Freitag, Lackharze, C. Hanser Verlag, 1996, p. 49 or else WO 93/15849. As polyesterpolyols it is also possible to use polyadducts of caprolactone with low molecular mass diols and triols, as available, for example, under the name TONE (Union Carbide Corp.) or CAPA (Solvay/ Interox). The arithmetically determined number-average molar weight is preferably from 500 to 5000 g/mol, more preferably from 800 to 3000 g/mol, the mean functionality from 2.0 to 4.0, preferably from 2.0 to 3.5.

Polyols containing urethane groups and ester groups for inventive use include in principle those described in EP 140 186. Preference is given to polyols containing urethane groups and ester groups that are prepared using HDI, IPDI, trimethylhexamethylene diisocyanate (TMDI) or (Hi2-MDI). The number-average molar weight is preferably from 500 to 2000 g/mol, the mean functionality from 2.0 to 3.5.

The mixing ratio of crosslinker to polyol varies between 5:95 and 50:50% by weight, based on the weight of the nonvolatile constituents, according to the desired profile of properties of the cured coating.

The coating materials of the invention can comprise the solvents known in coatings technology, examples being ketones, esters or aromatics, and auxiliaries such as stabilizers, including light stabilizers, catalysts, leveling agents or Theological aids, such as sag control agents, microgels or pyrogenic silica, in typical concentrations.

Particularly suitable catalysts are those which have become established in the field of PU technology, such as organic Sn(IV), Sn(II), Zn and Bi compounds or tertiary amines (PU catalysts), in amounts of from 0.1 to 2% by weight.

If necessary it is also possible to incorporate organic or inorganic color and/or effect pigments which are customary in coatings technology.

Coating materials based on the NCO compounds of the invention with covalently bonded polyhedral oligomeric silicon-oxygen cluster units as crosslinkers can be solvent-based or solvent-free.

The coating materials based on the compounds of the invention can be applied by known methods such as spraying, dipping, rolling or knife coating. The substrate to be coated may have already been provided with other coating films.

The coating materials are also suitable for use as clear coat material, in which case this material is applied by the wet-on-wet method to one or more basecoat films, which are then cured jointly.

Curing of the coating materials of the invention takes place in the temperature range from 20 to 250° C. (substrate temperature).

### EXAMPLES

The examples below are intended to illustrate the invention, without any intention that the invention should be restricted to this embodiment.

Preparation of the Polyhedral Oligomeric Silicon-oxygen Cluster Unit

### Example 1a

### Synthesis of (isobutyl)₈Si₈O12

To a solution of 446 g (2.5 mol) of isobutyltrimethoxysilane (isobutyl)Si(OMe)₃ (DYNASYLAN® IBTMO, Degussa AG) in 4300 ml of acetone there is added with stirring a solution of 6.4 g (0.11 mol) of KOH in 200 ml of water. The reaction mixture is subsequently stirred at 30° C. for 3 days. The precipitate formed is removed by filtration and dried under reduced pressure at 70° C. The product, (isobutyl)₈Si₈O₁₂, is obtained in a yield of 262 g.

### Example 1b

### Synthesis of (isobutyl)₇Si₇O₉(OH)₃

At a temperature of 55° C. 55 g (63 mmol) of (isobutyl)₈Si₈O₈₁₂ are added to 500 ml of an acetone/ methanol mixture (volume ratio 84:16) containing 5.0 ml (278 mmol) of H₂O and 10.0 g (437 mmol) of LiOH. The reaction mixture is subsequently stirred at 55° C. for 18 hours and then added to 500 ml of 1 N hydrochloric acid. After 5 minutes' stirring the solid obtained is removed by filtration and washed with 100 ml of methanol. Drying in air gives 54.8 g of (isobutyl)₇Si₇O₉(OH)₃.

### Example 1c

### Synthesis of (3-aminopropyl)(isobutyl)₇Si₈O₁₂

To a solution of 20 g (25.3 mmol) of (isobutyl)₇Si₇O₉(OH)₃ (from Example 1b) in 20 ml of tetrahydrofuran there are added at 20° C. 4.67 g (26 mmol) of 3-aminopropyl triethoxysilane (DYNASYLAN® AMEO, Degussa AG). The mixture is subsequently stirred overnight. Thereafter the reaction solution is admixed over 3 minutes with 100 ml of methanol. Filtration, washing of the solid product with methanol, and subsequent drying gives 17 g of (3-aminopropyl)(isobutyl)₇Si₈O₁₂ (77% yield) as a white powder.

Examples 2 and 3 and comparative example A employ the following compounds:

Synthalan HS 86B: acrylate resin, Synthopol, OH number: 120 mg KOH/g, supplied in Shellsol A/butyl acetate (4:1)

VESTANAT T 1890:cycloaliphatic polyisocyanate, Degussa AG, NCO content: 17.1%

DBTL: dibutyltin dilaurate, 10% in butyl acetate

BYK 331: leveling additive Byk Chemie

### Example 2 (Inventive)

### Polyurethane Coating Crosslinker with Covalently Bonded Polyhedral Oligomeric Silicon-oxygen Cluster Unit

14.9 parts by weight of VESTANAT T 1890/100 (IPDI-based polyisocyanate) are dissolved at 40° C. in 70.8 parts by weight of o-xylene and the solution is admixed with 0.5 part by weight of DBTL solution and 0.2 part by weight of Byk 331. Then 5.4 parts by weight of silicon-oxygen cluster unit from Example 1c are stirred in. After a few minutes the slightly exothermic reaction is complete.

### Example 3: (Inventive)

### Polyurethane Coating Formulation with Covalently Bonded Polyhedral Oligomeric Silicon-oxygen Cluster Unit

31.1 parts by weight of Synthalan HS 86B are added to the reaction product from Example 2 and stirred in vigorously. Xylene is used to set a viscosity of 20 sec in the DIN 4 cup. This clear solution is applied by spraying to Bonder OC 265 (phosphated steel panels) and cured at 140° C. for 25 minutes. The surface is completely flawless. The gloss (60°) is 88%.

### Comparative Example A (Comparative)

### Polyurethane Coating Formulation with Polyhedral Oligomeric Silicon-oxygen Cluster Unit Not Covalently Bonded

14.9 parts by weight of VESTANAT T 1890/100 (IPDI-based polyisocyanate) are dissolved at 40° C. in 70.8 parts by weight of o-xylene and the solution is admixed with 0.5 part by weight of DBTL solution and 0.2 part by weight of Byk 331. Then 5.4 parts by weight of silicon-oxygen cluster unit from Example 1 a are stirred in. Finally 34.5 parts by weight of Synthalan HS 86B are added and stirred in vigorously. Xylene is used to set a viscosity of 20 sec in the DIN 4 cup. This solution, which is still slightly cloudy, is applied by spraying to Bonder OC 265 (phosphated steel panels) and cured at 140° C. for 25 minutes. The surface is highly disrupted. It is therefore impossible to determine gloss.

Examples 2 and 3 in contrast to Comparative example A show that by virtue of an inventive covalent attachment of the polyhedral oligomeric silicon-oxygen cluster unit the compatibility of crosslinker resins can be significantly improved and the coating film surfaces are substantially less disrupted.

The disclosure of the priority document, German Application No. 103 31 787.2, filed Jul. 11, 2003, is incorporated by reference herein in its entirety.

1. An NCO compound with covalently bonded polyhedral oligomeric silicon-oxygen cluster units, the NCO compound being synthesized by reacting as starting components
A) at least one aromatic, aliphatic and/or cycloaliphatic polyisocyanate with free isocyanate groups and having an NCO functionality of from 2 to 6,
B) from 0.001 to 20.0% by weight of polyhedral oligomeric silicon-oxygen cluster units having at least one functional group reactive toward isocyanate groups, and
C) optionally, a blocking agent,
wherein in the NCO compound
100 mol % of the free isocyanate groups originally present in the component A) have undergone reaction; and
from 1 to 20 mol % of the free isocyanate groups originally present in the component A) have undergone reaction with the component B); and
wherein, when the optional component C) is one of the starting components, in the NCO compound
from 80 to 99 mol % of the free isocyanate groups originally present in the component A) have undergone reaction with the optional component C).

2. The NCO compound as claimed in claim 1, wherein the polyisocyanate A) comprises a diisocyanate selected from the group consisting of HDI, IPDI, H₁₂-MDI, TMXDI, 1,3-H-XDI, TMDI, MPDI, NBDI, LTI, TDI, MDI and NTI.

3. The NCO compound as claimed in claim 1, wherein the component A) comprises polyisocyanates obtained by trimerization, dimerization or formation of urethane, biuret or allophanate, alone or in mixtures.

4. The NCO compound as claimed in claim 1, wherein the component A) comprises mixtures of polyisocyanates and monomeric diisocyanates.

5. The NCO compound as claimed in claim 1, wherein the polyisocyanate is chain-extended or branched.

6. The NCO compound as claimed in claim 1, wherein the component A) comprises at least one of IPDI, HDI, derivatives of IPDI, and derivatives of HDI.

7. The NCO compound as claimed in claim 1, wherein the component B) comprises polyhedral oligomeric silicon-oxygen cluster units in accordance with the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
where:
a,b,c=0-1; d=1-2; e,f,g=0-3; h=1-4; m+n+o+p≧4; a+b=1; c+d=2; e+f=3 and g+h=4;
R=a hydrogen atom, alkyl, cycloalkyl, alkenyl, cycloalkenyl, alkynyl or cycloalkynyl group or polymer unit, each of which is substituted or unsubstituted, or further functionalized polyhedral oligomeric silicon-oxygen cluster units attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino, phosphine or polyether group, or substituents of type R containing at least one such group of type X,
the substituents of type R being identical or different, and
the substituents of type X being identical or different.

8. The NCO compound as claimed in claim 7, wherein each of the polyhedral oligomeric silicon-oxygen cluster units is functionalized, with X comprising a functional group.

9. The NCO compound as claimed in claim 7, wherein at least one of the substituents of type X comprises an amino group.

10. The NCO compound as claimed in claim 7, wherein at least one of the substituents of type X comprises a blocked or nonblocked isocyanate group.

11. The NCO compound as claimed in claim 7, wherein at least one of the substituents of type X comprises an acrylate or methacrylate group.

12. The NCO compound as claimed in claim 7, wherein at least one of the substituents of type X comprises an alkoxysilyl or alkoxysilylalkyl group.

13. The NCO compound as claimed in claim 7, wherein at least one of the substituents of type X comprises an epoxy group.

14. The NCO compound as claimed in claim 7, wherein at least one of the substituents of type X comprises a hydroxyl group.

15. The NCO compound as claimed in claim 7, wherein at least two of the substituents are of type X.

16. The NCO compound as claimed in claim 7, wherein at least two of the substituents of type X are identical.

17. The NCO compound as claimed in claim 8, wherein each of the functionalized polyhedral oligomeric silicon-oxygen cluster units is based essentially on structure 3 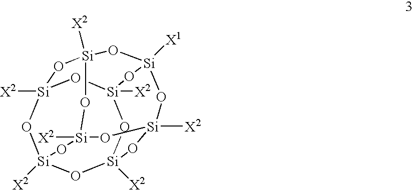
where X¹=substituent of type X or of type —O—SiX₃, X²=substituent of type X, of type —O—SiX₃, of type R, of type —O—SiX₂R, of type —O—SiXR₂ or of type —O—SiR₃.

18. The NCO compound as claimed in claim 8, wherein each of the functionalized polyhedral oligomeric silicon-oxygen cluster units is a functionalized oligomeric silsesquioxane unit.

19. The NCO compound as claimed in claim 18, wherein the silsesquioxane unit has a functionalized homoleptic structure, with all substituents of type R being identical.

20. The NCO compound as claimed in claim 18, wherein the silsesquioxane unit has a functionalized heteroleptic structure, with at least two of the substituents of type R being different.

21. The NCO compound as claimed in claim 18, wherein the functionalized oligomeric silsesquioxane unit is obtained by reacting silsesquioxane units having free hydroxyl groups with monomeric functionalized silanes of structure Y₃Si—X¹, Y₂SiX¹X², and YSiX¹X²X³, the substituent Y being a leaving group selected from alkoxy, carboxyl, halo, silyloxy, and amino group, and the substituents X¹, X² and X³ being of type X and being identical or different.

22. The NCO compound as claimed in claim 18, wherein the functionalized oligomeric silsesquioxane unit is based essentially on structure 4, 5 or 6

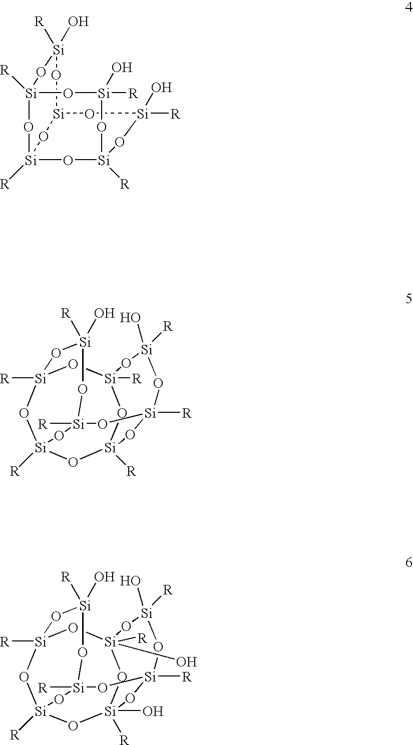

23. The NCO compound as claimed in claim 18, wherein the functionalized oligomeric silsesquioxane unit is based essentially on structure 7 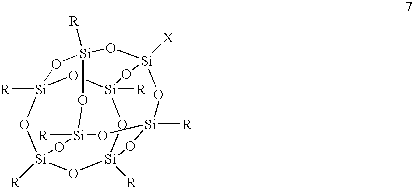
with R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group, or substituents of type R containing at least one such group of type X,
the substituents of type R being identical or different, and
the substituents of type X being identical or different.

24. The NCO compound as claimed in claim 1, wherein each of the polyhedral oligomeric silicon-oxygen cluster units is a nonfunctionalized oligomeric silsesquioxane unit.

25. The NCO compound as claimed in claim 8, wherein each of the functionalized polyhedral oligomeric silicon-oxygen cluster units is a functionalized oligomeric spherosilicate unit.

26. The NCO compound as claimed in claim 1, wherein each of the polyhedral oligomeric silicon-oxygen cluster units is a nonfunctionalized oligomeric spherosilicate unit.

27. The NCO compound as claimed in claim 1, wherein the blocking agent C) comprises at least one selected from the group consisting of ketoximes, aldoximes, substituted and unsubstituted 1,2,4-triazoles, substituted and unsubstituted pyrazoles, 3,5-dimethylpyrazole, ε-caprolactam, malonates, acetoacetates, phenol, substituted phenols, secondary amines, and C1-C10 monoalcohols.

28. A coating material comprising at least one polyol component; and, as crosslinker, the NCO compound of claim 1.

29. The coating material as claimed in claim 28, wherein the at least one polyol component comprises at least one hydroxyl-containing resin selected from the group consisting of hydroxyl-containing (meth)acrylic copolymers, saturated polyesterpolyols, polycarbonatediols, polyetherpolyols, and polyols containing urethane groups and ester groups.

30. The coating material as claimed in claim 29, wherein
the at least one hydroxyl-containing resin comprises the (meth)acrylic copolymers, and
the (meth)acrylic copolymers have a number-average molar weight of from 2000 to 20000 g/mol, a glass transition temperature of from −40 to +60° C., and a hydroxyl content of from 30 to 250 mg KOH/g.

31. The coating material as claimed in claim 30, wherein
the at least one hydroxyl-containing resin comprises the polyesterpolyols, and
the polyesterpolyols have a mean functionality of from 2.0 to 4.0 and a number-average molar weight of from 500 to 10000 g/mol.

32. The coating material as claimed in claim 29, wherein the ratio of the at least one polyol component to the crosslinker is from 95:5 to 50:50% by weight.

33. The coating material as claimed in claim 29, further comprising auxiliaries.

34. The coating material as claimed in claim 33, wherein the auxiliaries comprise at least one selected from the group consisting of stabilizers, light stabilizers, catalysts, leveling agents, rheological aids, microgels, pigments and pyrogenic silica.

35. The coating material as claimed in claim 29, further comprising 0.1-2% by weight of a catalyst selected from the group consisting of organic Sn(IV) compounds, organic Sn(II) compounds, organic Zn compounds, organic Bi compounds, and tertiary amines.

36. The coating material as claimed in claim 29, further comprising a solvent.

37. A coating produced by coating on a surface the coating material of claim 29.
